(19) United States
(12) Patent Application Publication
(10) Pub. No.: US 2023/0229337 A1
(43) Pub. Date: Jul. 20, 2023

(54) INSTRUCTION AND DATA RECORDING APPARATUS EMBEDDED IN A HOST CONTROLLER

(71) Applicant: INNOGRIT TECHNOLOGIES CO., LTD., Shanghai (CN)

(72) Inventors: Moyang Chen, Shanghai (CN); Jie Chen, Shanghai (CN)

(21) Appl. No.: 17/886,481

(22) Filed: Aug. 12, 2022

(30) Foreign Application Priority Data
Jan. 17, 2022 (CN) 2022100461290

(51) Int. Cl. G06F 3/06

(52) U.S. Cl. CPC G06F 3/0653; G06F 3/0659; G06F 3/0604; G06F 3/0679

(57) ABSTRACT

An instruction and data recording apparatus embedded in a host controller includes one or more channels, each coupled to memory devices, and a storage controller coupled to the channels having a storage control module and an internal memory. The storage control module comprises a command/address transmission channel, a data write channel and a data read channel, and a channel information monitoring module configured to capture instruction flow transmitted on the command/address transmission channel, and data flow transmitted on the data write and data read channels, and to record instruction and data items to the internal memory according to the instruction and data flows. The channel information monitoring module is configured to capture the instruction and data flows in a form of digital signals instead of analog signals at the physical layers. Any occurrence of a valid instruction flow or data flow event is treated as a single item.

### CROSS REFERENCE TO RELATED APPLICATION

This application claims benefit to Chinese Patent Application No. CN 2022100461290, filed on Jan. 17, 2022, which is hereby incorporated by reference herein.

### FIELD

This disclosure relates to the field of storage technology, and more specifically to an instruction and data recording apparatus embedded in a host controller.

### BACKGROUND

Traditional schemes use an oscilloscope, or a logic analyzer, or a special protocol analyzer to observe and capture data transmission signals. At the same time, it requires the reservation of contact pins for signal observation on a circuit board, and manual work of connecting signal lines to the probe of measuring instruments.

Nowadays, the data transmission rate of flash memory interface is getting faster and faster. With the release of ONFI5.0, the data transmission rate of flash memory interface will reach 2400 MT/s. Using any traditional method, such as external instruments, to observe and capture multiple high-speed signals and then record history data (especially parallel transmission, such as ONFI and Toggle interfaces) will become harder, and it is difficult to guarantee accuracy or reliability.

The transmission interface signals of flash memory consist of these following signals:

Unidirectional transmission signals: WE_n, RE_n, RE, CLE, ALE, CE0˜CE7;
Bidirectional transmission signals: DQ0˜DQ7, DQS_t, DQS_c.

Typically, in a host controller, the data interface for flash memory is comprised of 4 to 8 channels. When all channels are needed to be observed and recorded at the same time, the cost of using external instruments for observation will become very high.

Furthermore, when debugging a read operation of a host controller chip, the signals and waveforms on the flash memory interface cannot accurately reflect the signal value actually sampled inside the host controller.

### SUMMARY

In an embodiment, the present invention provides an instruction and data recording apparatus embedded in a host controller. The instruction and data recording apparatus includes one or more channels and a storage controller. Each channel is coupled to multiple memory devices. The storage controller is coupled to the one or more channels and comprises a storage control module and an internal memory. The storage control module comprises a command/address transmission channel, a data write channel and a data read channel, and a channel information monitoring module configured to capture instruction flow transmitted on the command/address transmission channel, and data flow transmitted on the data write channel and the data read channel, and to record instruction and data items to the internal memory according to the instruction flow and the data flow. The storage control module is configured to communicate with the memory devices on the one or more channels via the command/address transmission channel, the data write channel and the data read channel. Each of the command/address transmission channel, the data write channel and the data read channel is configured to perform data transmission with the one or more channels via a physical layer. The channel information monitoring module is configured to capture the instruction flow and the data flow in a form of digital signals instead of a form of analog signals at the physical layers, whereby any occurrence of a valid instruction flow or data flow event is treated as a single item.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a block diagram of an instruction and data recording apparatus embedded in a host controller according to an embodiment of the present invention;

FIG. 2 shows a schematic diagram of an item record/entry according to an embodiment of the present invention;

FIG. 3 shows a schematic diagram of a data transmission process in a flash control module according to an embodiment of the present invention;

FIG. 4 shows a schematic diagram of an event occurrence determination process according to an embodiment of the present invention; and

FIG. 5 is a schematic diagram illustrating an operation process of an instruction and data recording apparatus embedded in a host controller according to an embodiment of the present invention.

### DETAILED DESCRIPTION

In an embodiment, the present invention provides an instruction and data recording apparatus embedded in host controller, which can improve debugging efficiency, has no additional cost of special instruments, is able to support up to the number of physical channels and cope with external physical data transmission rate, and also maintain high configuration flexibility.

The instruction and data recording apparatus embedded in a host controller according to an embodiment of the present invention comprises:

one or more channels, each of which is coupled with multiple memory devices; and

a storage controller coupled to the one or more channels, the storage controller comprising a storage control module and an internal memory;

wherein, the storage control module comprises:

a command/address transmission channel, a data write channel and a data read channel, wherein the storage control module communicates with the memory devices on the one or more channels via the command/address transmission channel, the data write channel and the data read channel, and each of the command/address transmission channel, the data write channel and the data read channel performs data transmission with the one or more channels via a physical layer; and

a channel information monitoring module configured to capture the instruction flow transmitted on the command/address transmission channel, and the data flow transmitted on the data write channel and the data read channel, and to record the instruction and data items to the internal memory according to the instruction flow and data flow, wherein, the channel information monitoring module captures the instruction flow and data flow in the form of digital signals instead of the form of analog signals at the physical layers. Any occurrence of valid instruction flow or data flow event is treated as a single item.

In a preferred embodiment, the instruction and data items include the item serial number, the item type, the channel number, the memory device number, the instruction word or data word, and the time when the item occurred.

In a preferred embodiment, the item type includes a command, an address, write operation data and read operation data. The instruction word is a command word or an address word. The data word is write operation data or read operation data, which correspond to a range of transmission data designated by the offset and the length.

In a preferred embodiment, the channel information monitoring module is configured to be triggered by an instruction, data, an instruction sequence or a data sequence specified on the command/address transmission channel, the data write channel or the data read channel. After the triggering, it starts recording corresponding instruction and data items into the internal memory.

In a preferred embodiment, the channel information monitoring module is further configured to trigger an error report and immediately stop recording items when the data read channel does not receive the data returned by the memory device during the read operation of the memory device on the one or more channels by the storage controller.

In a preferred embodiment, the channel information monitoring module is further configured to trigger an error report and immediately stop recording items when the times of consecutive capture of the same instruction exceeds a predetermined threshold.

In a preferred embodiment, the channel information monitoring module is configured to capture the instruction flow and the data flow on one or more channels.

In a preferred embodiment, the recording apparatus further includes the internal memory and an external memory coupled to the channel information monitoring module, and the channel information monitoring module dumps instruction and data items to the internal memory or the external memory.

In a preferred embodiment, the internal memory is configured to dump the instruction and data items stored therein to the external memory before the storage controller is powered off

In a preferred embodiment, the internal memory is a Static Random Access Memory located inside the storage controller, and the external memory is a Random Access Memory located outside the storage controller.

In a preferred embodiment, the recording device further includes: an external non-volatile memory coupled to the internal memory and an external memory, the external non-volatile memory being used to store the instruction and data items stored in the internal memory or the external memory.

Compared with the prior art, embodiments of the present invention provide at least the beneficial effects described in the following.

In an embodiment, a channel information monitoring module is embedded in the host controller chip of the storage system, and the instruction/data signals information is recorded from the perspective of the main controller chip, which can greatly improve the debugging efficiency, and there is no additional cost of special instruments, and is able to support up to the number of external physical channels and cope with the external physical data transmission rate, and also maintain high configuration flexibility.

A large number of technical features are described in the present specification, and are distributed in various technical solutions. If a combination or a technical solution of all possible technical features of the present specification is listed, the description may be made too long. In order to avoid this problem, the various technical features disclosed in the above summary of the present specification, the technical features disclosed in the various embodiments and examples below, and the various technical features disclosed in the drawings can be freely combined with each other to constitute various new technical solutions (all of which are considered to have been described in this specification), unless a combination of such technical features is not technically feasible. For example, feature A+B+C is disclosed in one example, and feature A+B+D+E is disclosed in another example, while features C and D are equivalent technical means that perform the same function, and technically only choose one, not to adopt at the same time. Feature E can be combined with feature C technically. Then, the A+B+C+D scheme should not be regarded as already recorded because of the technical infeasibility, and A+B+C+E scheme should be considered as already documented.

In the following description, numerous technical details are set forth in order to provide the reader with a better understanding of embodiments of the present invention. However, those skilled in the art can understand that the technical solutions can be implemented without these technical details and various changes and modifications can be made based on the following exemplary embodiments.

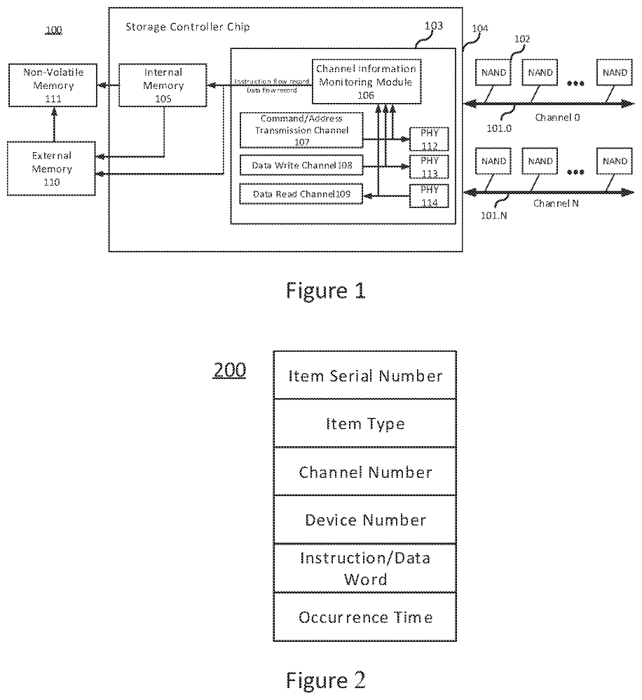

In an embodiment, the present invention provides an instruction and data recording apparatus embedded in a host controller. FIG. 1 shows a block diagram of the instruction and data recording apparatus embedded in host controller 100 in an embodiment of the present invention, the apparatus 100 comprises one or more channels, and a storage controller 104 coupled to the one or more channels. For example, the apparatus 100 comprises a first channel 101.0, . . . , an n-th channel 101.N. each of the channels 101.0˜101.N is coupled to a plurality of memory devices 102. When the storage controller 104 is coupled to a host, the host may be provided with data storage and/or access to stored data. The memory device 102 may be non-volatile memory (NVM) based memory device, and may include, for example, NAND flash memory, NOR flash memory, magnetoresistive random access memory (MRAM), resistive random access memory (RRAM), phase change random access memory (PCRAM), Nano-RAM, etc. NAND flash memory may be used as an example to demonstrate the embedded instruction and data recording technology. However, various embodiments according to the present disclosure may utilize other types of non-volatile storage devices to implement the technology.

The storage controller 104 comprises a storage control module 103 and an internal memory 105. The storage control module 103 comprises a command/address transmission channel 107, a data write channel 108, a data read channel 109, and a channel information monitoring module 106. The storage control module 103 communicate with the memory device(s) 102 on the channels 101.0˜101.N via the command/address transmission channel 107, the data write channel 108, and the data read channel 109. The storage control module 103 transmit commands and addresses to the memory devices 102 via the command/address transmission channel 107. The storage control module 103 transmit data to be written to the memory device(s) 102 via the data write channel 108. The memory device(s) 102 transmit data to be read to the storage control module 103 via the data read channel 109. Wherein, the storage control module 103 can communicate with NANDs on the one or more channels at the same time.

It should be noted that a physical layer (PHY) 112 converts the commands and addresses that the storage control module 103 transmitted to the channel 101 via the command/address transmission channel 107 into analog signals. A physical layer 113 converts the data transmitted by the storage control module 103 to the channel 101 via the data write channel 108 into analog signals. A physical layer 114 converts the data transmitted by the channel 101 to the storage control module 103 via the data read channel 109 into digital signals.

The channel information monitoring module 106 is configured to capture the instruction flow transmitted on the command/address transmission channel 107 and the data flow transmitted on the data write channel 108 and the data read channel 109, and record the instruction and data items to the internal memory 105 according to the instruction flow and the data flow.

FIG. 2 is a schematic structural diagram of an item record 200 in an embodiment of the present invention. In one embodiment, the instruction and data item comprises an item serial number, an item type, a channel number, a memory device number, an instruction word or data word, and an item occurrence time. Wherein the item type may comprise a command, an address, write operation data and read operation data. The instruction word may be a command word or an address word. The data word can be the write operation data or the read operation data corresponding to the specified captured byte start address and the number of bytes. The item occurrence time may be the counter value provided by a timer.

In one embodiment, the channel information monitoring module 106 is configured to be triggered by an instruction, data, an instruction sequence, or a data sequence specified on the command/address transmission channel 107, the data write channel 108, or the data read channel 109, and to record the corresponding instruction and data items into the internal memory 105. During monitoring process, the channel information monitoring module 106 may monitor specific instructions, data, instruction sequences, or data sequences as needed.

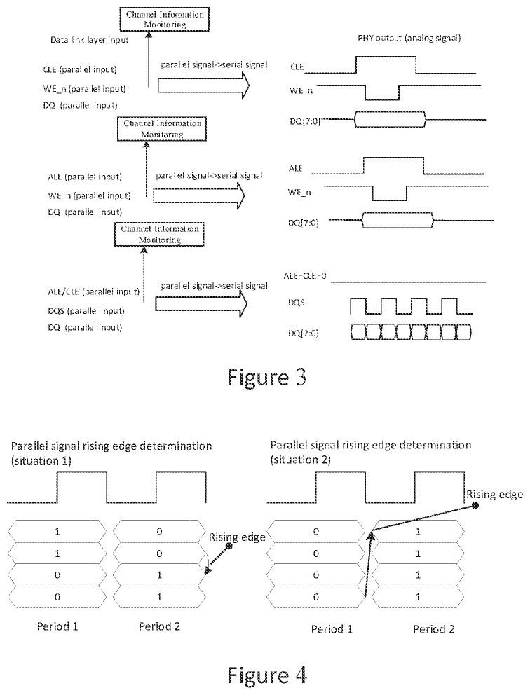

FIG. 3 shows a schematic diagram of a data transmission process in the flash control module in an embodiment of the present invention. Instructions and data input on the data link layer of the command/address transmission channel 107, the data write channel 108 and the data read channel 109 are digital signals, which may be converted into analog signals via the physical layers. The traditional signal capture and sampling method based on oscilloscope or external logic analyzer requires manual connections of physical interfaces and signal lines, and is based on the sampling of analog signals driven by the physical layer. The whole process involves D/A conversion of the physical layer and A/D conversion of the oscilloscope or external logic analyzer. It is necessary to consider the interference of external noise and the impact of measurement probes (from oscilloscope/logic analyzer). As the bus rate increases, accurate sampling of high-speed analog signals (2.4 Gbps or even higher) becomes much more difficult. The channel information monitoring module of embodiments of the present invention is embedded in the flash control module, does not need the connection of the external signal line, can directly capture the internal digital signals, the sampling in the digital domain only needs to involve digital circuit, which can ensure the accuracy of sampling.

In addition, in the implementation of the physical layer, there is a conversion circuit of parallel signals to serial signals. Taking 2400 MT/s rate and the parallel-to-serial conversion mode of 1:4 as an example, the operating frequency of the parallel signals is 600 MHz. The channel information monitoring module of embodiments of the present invention directly samples the parallel signals. Take command/address signals sampling as an example. The rising edge of WE_n is determined by the 0->1 transition occurs, and the determination method of the rising edge is shown in FIG. 4. In the period in which the 0->1 transition occurs (period 2 in FIG. 4), the corresponding DQ signal is captured to obtain the corresponding command/address data. The entire logic of embodiments of the present invention works in digital domain, does not involve analog-to-digital conversion, and operates at a lower frequency (for example, 600 MHz frequency), which can ensure the accuracy of sampling.

The traditional signal capture method based on oscilloscope or external logic analyzer, for NAND interface signals, sampling is carried out externally, which is prone to sampling errors at high-speed transmission rate. If the captured instruction/address signals are wrong, it will impair the engineer's judgement and incur more debugging effort. In addition, the data captured by the oscilloscope and the external logic analyzer are usually raw data, and the debugging efforts are required to manually identify and analyze the command/address signals and read and write data signals. In order to reduce the workload, the protocol analyzer may be further purchased to parse the captured data, but additional costs are required. In embodiments of the present invention, the signal captured is already classified as different time types (command/address/write data/read data), and there is no need to parse the data at protocol level, thus improving the debugging efficiency.

In embodiments of the present invention, system errors can be captured according to the instruction flow or the data flow monitored by the channel information monitoring module 106. For example, in one embodiment, the channel information monitoring module 106 is configured to trigger an error report when the data read channel 109 does not receive data returned by the memory device(s) 102 during a read operation of the memory device(s) 102 on the one or more channels 101.0-101, and to allow it to be configured to immediately stop recording items. As another example, in one embodiment, the channel information monitoring module 106 is configured to trigger an error report when the times of consecutive capture of the same instruction exceeds a predetermined threshold, and to allow it to be configured to immediately stop recording items.

In one embodiment, the channel information monitoring module 106 is configured to capture the instruction flow and the data flow on one or more of the one or more channels 101.0 to 101.N. The recording apparatus of embodiments of the present invention has the ability to capture instructions and data flow on all channels concurrently, and can be configured to capture instruction flow or data flow on one or more specified channels as needed.

In an embodiment, the present invention provides a digital logic circuit, in which the memory and the channel information monitoring module are embedded in a host controller of a storage system, and information of instruction/data signals are recorded from the perspective of storing the host controller, which can greatly improve the debugging efficiency, has no additional cost of special instruments, is not limited to the number of external physical channels and the external physical data transmission rate, and has high configuration flexibility.

In one or more embodiments, the recording apparatus 100 further comprises an external memory 110 coupled to the channel information monitoring module 106, and the channel information monitoring module 106 may dump the instruction and data items to the internal memory 105 or the external memory 110 according to the configuration. Also, the internal memory 105 is configured to dump the instruction and data items stored therein to the external memory 110 before the storage controller is 104 powered off.

In one embodiment, the internal memory 105 is a static random access memory (RAM) located inside the storage controller 104, and the external memory 110 is a RAM (e.g., DDR) located outside the storage controller 104.

In yet another embodiment, the recording apparatus 100 further comprises an external non-volatile memory (e.g., NAND) 111 coupled to the internal memory and the external memory. The external non-volatile memory 111 is used to store the instruction and data items stored in the internal memory 105 or the external memory 110.

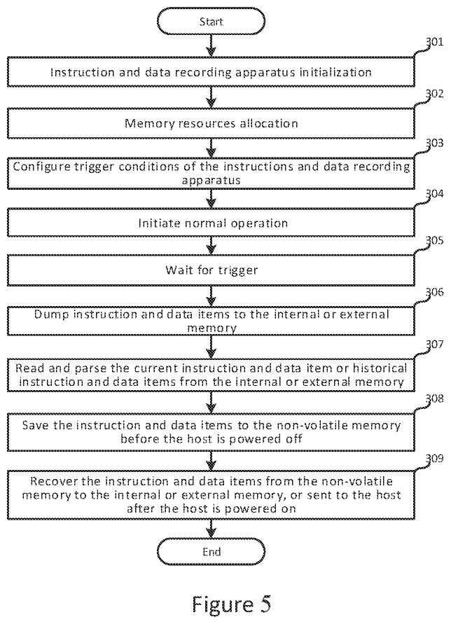

FIG. 5 is a schematic diagram illustrating an operation process of the instruction and data recording apparatus embedded in a host controller according to an embodiment of the present invention. In one embodiment, the instruction and data recording apparatus embedded in the host controller is configured to perform to the following steps to record instruction and data items:

Step 301, instruction and data recording apparatus initialization.

Step 302, memory resources allocation.

Step 303, configure trigger conditions of the instructions and data recording apparatus. The Step 303 is optional. When it's omitted, it works at continuously triggering mode.

Step 304, initiate the normal operation.

Step 305, wait for the trigger. The Step 305 is optional. When trigger conditions needs to be specified, perform this step.

Step 306, dump instruction and data items to the internal or external memory.

Step 307, read and parse the instruction and data item or historical instruction and data items from the internal or external memory.

Step 308, save the instruction and data items to the non-volatile memory before the host is powered off.

Step 309, recover the instruction and data items from the non-volatile memory to the internal or external memory, or sent to the host after the host is powered on.

The recording apparatus according to embodiments of the present invention can achieve the following effects:

1) It can be compatible with the overall SoC architecture of the current flash control chip, operate independently in the background, does not affect the transmission of normal commands and data flow, and is transparent to software development. Real data inside the flash control chip can be observed and sampled in real time without affecting the overall system performance.

2) The monitoring module and the internal memory can be embedded in the flash control chip, not limited to the data transmission rate of the physical interface, not limited to the number of physical channels, no additional purchase of external measurement instruments, no need for manual connection of the board-level signal line. Overall cost is reduced.

3) The single storage capacity of the item is low, and the amount of data captured is only limited by the capacity of the internal/external memory of the flash control chip. For example, using DDR can support long-term data capture.

4) System errors can be captured, such as the NAND chip does not return a DQS signal, or the NAND chip is busy for too long and cannot return to the READY state.

5) It can support the capture of the count value of the time counter, which assists in measuring the execution time of instructions and analyze the data transmission performance of the interface, reduces the effort of product-level debugging, and improves the efficiency of on-site system debugging.

As used herein, relational terms such as first and second, and so on are only configured to distinguish one entity or operation from another entity or operation, and do not necessarily require or imply any such actual relationship or order between these entities or operations. Furthermore, the term “comprises” or “comprising” or “includes” or any other variations thereof is intended to encompass a non-exclusive inclusion, such that a process, method, article, or device that comprises a plurality of elements includes not only those elements but also other elements, or elements that are inherent to such a process, method, item, or device. Without more restrictions, the element defined by the phrase “include one” or the like does not exclude that there are other identical elements in the process, method, article or equipment that includes the element. In the present disclosure, if it is mentioned that an action is performed according to an element, it means the meaning of performing the action at least according to the element, and includes two cases: the behavior is performed only on the basis of the element, and the behavior is performed based on the element and other elements. Multiple, repeatedly, various, etc., expressions include 2, twice, 2 types, and 2 or more, twice or more, and 2 types or more types.

The term “coupled to” and its derivatives can be used herein. “Coupled” may mean that two or more elements are in direct physical or electrical contact. However, “coupled” may also mean that two or more elements are indirectly in contact with each other, but still cooperate or interact with each other, and may mean that one or more other elements are coupled between elements that are said to be coupled to or connected with each other.

All documents mentioned in the disclosure are considered to be included in the disclosure of the disclosure as a whole, so that they can be used as a basis for modification when necessary. In addition, it should be understood that after reading the content of the present disclosure, those skilled in the art can make various changes or modifications to the present disclosure, and these equivalent forms also fall within the scope of protection claimed by the present disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An instruction and data recording apparatus embedded in a host controller, the instruction and data recording apparatus comprising:
one or more channels, each of the one or more channels being coupled to multiple memory devices; and
a storage controller coupled to the one or more channels, the storage controller comprising a storage control module and an internal memory;
wherein, the storage control module comprises:
a command/address transmission channel, a data write channel and a data read channel, wherein the storage control module is configured to communicate with the memory devices on the one or more channels via the command/address transmission channel, the data write channel and the data read channel, and each of the command/address transmission channel, the data write channel and the data read channel is configured to perform data transmission with the one or more channels via a physical layer; and
a channel information monitoring module configured to capture instruction flow transmitted on the command/address transmission channel, and data flow transmitted on the data write channel and the data read channel, and to record instruction and data items to the internal memory according to the instruction flow and the data flow, wherein the channel information monitoring module is configured to capture the instruction flow and the data flow in a form of digital signals instead of a form of analog signals at the physical layers, whereby any occurrence of a valid instruction flow or data flow event is treated as a single item.

2. The instruction and data recording apparatus as recited in claim 1, wherein the instruction and data items comprise an item serial number, an item type, a channel number, a memory device number, an instruction word or a data word, and an item occurrence time.

3. The instruction and data recording apparatus as recited in claim 2, wherein the item type comprises one of a command, an address, a write operation data and a read operation data, the instruction word is a command word or an address word, and the data word is the write operation data or the read operation data, which correspond to a range of transmission data designated by an offset and a length.

4. The instruction and data recording apparatus as recited in claim 1, wherein the channel information monitoring module is further configured to be triggered by an instruction, data, an instruction sequence or a data sequence specified on the command/address transmission channel, the data write channel or the data read channel, and after triggering, to start recording corresponding instruction and data items in the internal memory.

5. The instruction and data recording apparatus as recited in claim 1, wherein the channel information monitoring module is further configured to trigger an error report and immediately stop recording items when the data read channel does not receive the data returned by the memory devices during read operation of the memory devices on the one or more channels by the storage controller.

6. The instruction and data recording apparatus as recited in claim 1, wherein the channel information monitoring module is further configured to trigger an error report and immediately stop recording items when times of consecutive capture of a same instruction exceeds a predetermined threshold.

7. The instruction and data recording apparatus as recited in claim 1, wherein the channel information monitoring module is further configured to capture the instruction flow and the data flow on the one or more channels.

8. The instruction and data recording apparatus as recited in claim 1, wherein the recording apparatus further comprises the internal memory and an external memory coupled to the channel information monitoring module, and wherein the channel information monitoring module is configured to dump the instruction and data items to the internal memory or the external memory.

9. The instruction and data recording apparatus as recited in claim 8, wherein the internal memory is configured to store the instruction and data items that are stored in the internal memory in the external memory before the storage controller is powered off.

10. The instruction and data recording apparatus as recited in claim 8, wherein the internal memory is a static random access memory located inside the storage controller, and the external memory is a random access memory located outside the storage controller.

11. The instruction and data recording apparatus as recited in claim 8, wherein the recording apparatus further comprises an external non-volatile memory coupled to the internal memory and the external memory, the external non-volatile memory being configured to store the instruction and data items stored in the internal memory or the external memory.
